(19) United States
(12) Patent Application Publication
(10) Pub. No.: US 2012/0309604 A1
(43) Pub. Date: Dec. 6, 2012

(54) LINER SYSTEM FOR A HOLDING CONTAINER

(75) Inventor: Cliff Wiebe, Calgary (CA)

(73) Assignee: POSEIDON CONCEPTS PARTNERSHIP LIMITED, Calgary (CA)

(21) Appl. No.: 13/153,343

(22) Filed: Jun. 3, 2011

(51) Int. Cl. B31B 7/00; B32B 3/02

(52) U.S. Cl. 493/95; 428/98

(57) ABSTRACT

A liner system and method for installing the liner. The liner is composed of a synthetic material (HDPE or LLDPE). The liner has a base and walls and an undersurface. The undersurface includes integral therewith a plurality of discrete and independent radially disposed in spaced relation stabilizing members. The stabilizing members are exposed when the walls of the liner are positioned in a substantially vertical orientation relative to the base. This exposes the stabilizing members. The container may then be positioned in segments on top of the stabilizing members with the walls of the liner adjacent a wall of the container. In this manner, the container structure is fabricated about the liner. The advantages in this system relate to the maintenance of tension of the liner and the avoidance of having to position a large disc like structure over the top and within a cylindrical receptacle or container. Conveniently, the container can be assembled about a liner expeditiously and at a fraction of the cost typically encountered with existing arrangements.

### FIELD OF THE INVENTION

The present invention relates to a liner and more particularly, the present invention relates to an improved liner for use in a holding container or reservoir and a method of lining such a reservoir or container.

### BACKGROUND OF THE INVENTION

Synthetic plastic liners have been used to line above and below ground reservoirs. The simplest example of this is a conventional swimming pool which provides an inground opening which is prepared and levelled and subsequently lined with a polyethylene and the like material. In industrial applications, for purposes of handling landfill, hazardous waste disposal, infer cilia, more sophisticated liners are required in order to comply with environmental regulations. In situations related to the latter, geomembranes composed of synthetic plastics are regularly used. One material that has been particularly useful in providing liners is high density polyethylene (HDPE). This material is particularly useful since it generally includes and retains UV stabilizers so that it does not prematurely degrade when exposed to the sun and conventionally has a very lengthy useful life span. Another useful material is linear low density polyethylene (LLDPE).

Returning to industrial applications, conventional liners are typically formed in segments which provides for adjacent segments being fusion welded in an imbricated manner to provide a fairly large liner. The liners are then manually installed by several workers and then custom fitted to the area which the liner will serve.

Examples of liners in the prior art include, for example, U.S. Pat. No. 4,065,924, issued Jan. 3, 1978 to Young. The patentee teaches a method of lining a waterway or reservoir. There are a number of steps taught for forming the membrane which comprises a laminate of a butyl sheet with a layer of synthetic fibres bonded thereto.

A conventional “drop in” style liner is described in U.S. Pat. No. 7,574,834, issued Aug. 18, 2009 to Murray. The liner is designed for above ground water storage and provides for a plurality of modular walls coupled together to form a continuous perimeter. Each of the walls is inclined relative to the horizontal. A liner covers an internal side of the modular walls and an area encompassed by the perimeter.

In terms of larger storage vessels, U.S. Patent Publication No. 2009/0139633, published Jun. 4, 2009, provides a method for lining a container and the liner itself. In the method, the patentee teaches a reservoir tank or basin having a waterproof layer of plastic where, in a first step, at least one of the fastening elements comprised of Velcro™ is fastened to the inner side of the container and in a second step, at least one sealing sheet of plastic is fastened to the first fastening member. There is no real challenge in handling the liner in this publication as it is a modular type liner.

Additional examples of existing technology in the liner field are taught in U.S. Pat. No. 3,683,628, issued Aug. 15, 1972 to Tabary and in U.S. Patent Reissued Pat. No. 35,272, reissued Jun. 11, 1996 to Mathieson, et.al.

The liner that is incorporated in the instant technology is used in the storage tanks which are illustrated, as an example, in the websites of Royal Liner and Fab-Seal.

In greater detail, the liner system that is contemplated by the present invention is specifically used in reservoirs designed to hold a liquid. In the case where the liquid is water, specific guidelines need to be followed and specific materials used to line the container.

The receptacles or containers containing the water are typically assembled on site. This is where the complication arises with the conventional arrangements. As discussed hereinabove, the liners are fairly large, i.e. greater than 50 feet in diameter or greater and accordingly, the size of the liner for use in lining such a structure is very large and difficult to manipulate. Generally speaking, in conventional methodology the liner is transported to the site. The receptacle or container is assembled, many of which are of a cylindrical geometry. Once assembled, the onerous task of lining the receptacle is undertaken. The problem is that the liner, owing to the size, is extremely difficult to manipulate and it must be dropped into position and then subsequently placed so that the vertical walls are covered and the liner extends over the top of the vertical walls. This is not without complications under the best of circumstances; the exercise is grossly encumbered during inclement weather conditions. Under wind conditions, the liner effectively becomes a sail and even a slight wind can become a potentially fatal situation to workers attempting to position and fasten down the liner to the structure. It has been known in the field that the liner can become completely disengaged from the container and drift down several properties away from its initial intended position. There have also been a significant number of injuries to the workers where the liner flails in the wind and can easily slap or even worse, transport a worker purely under the force of the wind with the liner.

Given the problems with the existing arrangements and the systems used to line containers presently employed, there exists a need to have a system that is efficient and is not affected by inclement weather conditions. The present invention is directed to solving the limitations of the prior art arrangements.

### SUMMARY OF THE INVENTION

One object of the invention is to provide an improved liner system and method of lining a container.

A further object of one embodiment of the present invention, there is provided a liner for a tank adapted to retain liquid, comprising: a liner body adapted to form a base and at least one vertical wall in a continuous structure; said at least one vertical wall of said liner adapted for folding over a supporting wall section; and stabilizing means integral with and positioned about the base of said base of said liner for stabilizing motion of said liner during assembly of said wall section when said wall section is positioned on top of said stabilizing means.

Conveniently, the stabilizing means may be simple, discrete extensions from the existing liner. These are preferably radially disposed about the periphery of the underside of the liner.

Of particular advantage is the fact that the material of which the liner is made is HDPE or LLDPE. The attributes of these materials are well documented in the art and it is further known by those skilled that these materials, once they have served a useful lifespan as a liner, can be reclaimed and used for further article formulation, an example of which is lawn furniture. In this manner, the liner technology of the instant invention has a “green” aspect and is not wasteful to the extent of existing arrangements.

Once the liner is in position over the top edges of the wall segments of which the container is composed, suitable fastening means may be used for securement.

In terms of positioning the liner within the receptacle, it has been found that by making use of the stabilizing members which are integral with the base of the liner body, all of the inherent dangers and complications attributed to the prior art are overcome.

The stabilizing members briefly described herein previously are of particular advantage, since the liner can be transported to the site, put into position where the receptacle is to be placed and then the container effectively built around the liner. This is in marked contrast to the existing methodology which builds the container first and subsequently drops the liner over and into the receptacle. As will be appreciated in the case of the latter, it is extremely difficult to position a large disc like article (the liner) into the substantially cylindrical container. This requires continuous manipulation in order to centre the liner within the cylindrical container, which is not only time consuming, but extremely challenging.

In the case of the instant technology, the stabilizing members have on the top thereof the wall segments of the cylindrical container. In this manner, the liner is placed, the sides of the liner lifted substantially vertical to the base of the liner as the wall segments of the container are positioned on the stabilizing members. This eliminates the possibility of any movement from wind of the liner since the stabilizing members are integral, i.e. fixedly secured to the underside of the liner base. The corollary advantage to this structure is that the liner is effectively maintained in a pretentioned state so that no adjustment manipulation is required for purposes of centering the liner within the cylindrical container.

Accordingly, a further object of another embodiment of the present invention is to provide a method stabilizing movement of a liner body during the lining of a container adapted to store a liquid comprising: providing a liner body having a base and walls folding to a substantially orthogonal position relative to said base; providing integrally connected stabilizing means separate from said walls for extending perpetually from said base when said walls are folded; positioning wall segments for forming said container on top of solid stabilizing means; and folding and securing liner walls over said wall segments, whereby said liner body and walls are stabilized against lift and movement during assembly of said container.

Although it is preferred that the material of which the liner is made comprise HDPE or LLDPE, other suitable materials will be readily apparent to those skilled in the art. Additional materials may include polyethylene terephthalate (PET), bisphenol polyethylene, polyvinyl chloride (PVC), and acrylonitrile butadiene styrene (ABS).

In an alternative embodiment instead of providing individual stabilizing members about the periphery of the base of the liner, the number of stabilizing members projecting from the base may be significantly reduced and include a ring of material (around HDPE or LLDPE material). In this manner, the stabilizing members would act as spacer members for spacing coaxially disposed ring for purposes of receiving the cylindrical wall members and thus achieving the same result of the stabilizing members when they are positioned about the perimeter in spaced relation and in significant quantity.

Having thus generally described the invention, reference will now be made to the accompanying drawings illustrating preferred embodiments.

### BRIEF DESCRIPTION OF THE DRAWINGS

FIG. 1 is a bottom plan view of the liner according to one embodiment of the present invention;

FIG. 2 is a perspective view of the top of the liner in accordance with one embodiment of the present invention;

FIG. 3 is a perspective view of the liner as positioned with a container structure;

FIGS. 4A through 4D are a series of side views in schematic representation of the liner in various dispositions during assembly of the container around the liner;

FIGS. 5 is a perspective view of the assembled container as lined with the liner of the present invention;

FIG. 6 is a bottom plan view of an alternate embodiment of the liner according to the present invention; and

FIG. 7 is an exploded view of FIG. 6.

Similar numerals employed in the drawings denote similar elements.

### DETAILED DESCRIPTION OF THE PREFERRED EMBODIMENTS

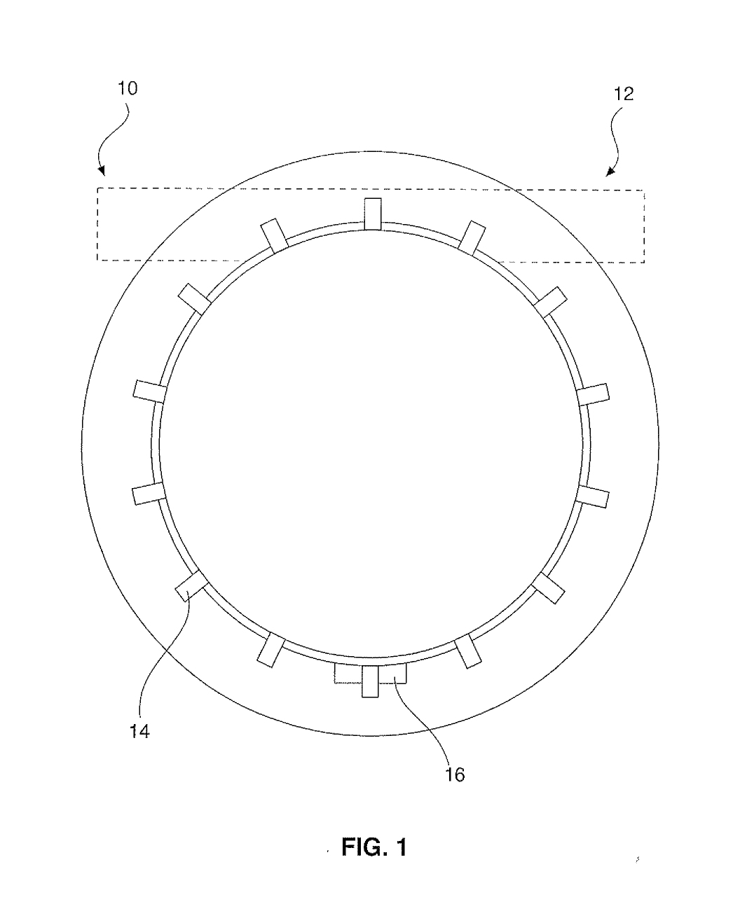

Referring now to FIG. 1, shown is a bottom plan view of the liner, globally denoted by numeral 10, according to one embodiment. The liner material composition has been discussed herein previously. The liner 10 is composed of a flexible impermeable material adapted to hold a liquid.

The liner is typically formed of a plurality of independent rectangular sections, shown in dashed line in FIG. 1 and represented by numeral 12. Although one rectangular section is shown, it will be appreciated that there are a plurality of such sections 12 which overly one another at least partially to provide a bonded surface. The bonding is typically achieved by butt welding, a process that is well known for formulating liners. Accordingly, the details of the process will not be discussed herein.

In FIG. 1, the liner 10 is shown in a circular form. The individual sections 12 are simply cut to render the liner in a circular structure as is shown in FIG. 1. The liner in this embodiment comprises a continuous circular sheet, the bottom of which includes a plurality of radially and equidistantly spaced projecting stabilizing members 14. The stabilizing members 14 are fixedly secured to the bottom of the liner and there may be any number of such members 14 associated with the bottom of the liner 10. It is preferred that there be included at least three such members 14.

As an option, the stabilizing members 14 may be positioned within a pouch 16 similarly located on the under surface of the liner at 10. This is to provide an area into which the individual stabilizing members 14 may be tucked in for storage. To this end, the pouches 16 are also integral with the liner and maintain the stabilizing members 14 in an orderly fashion.

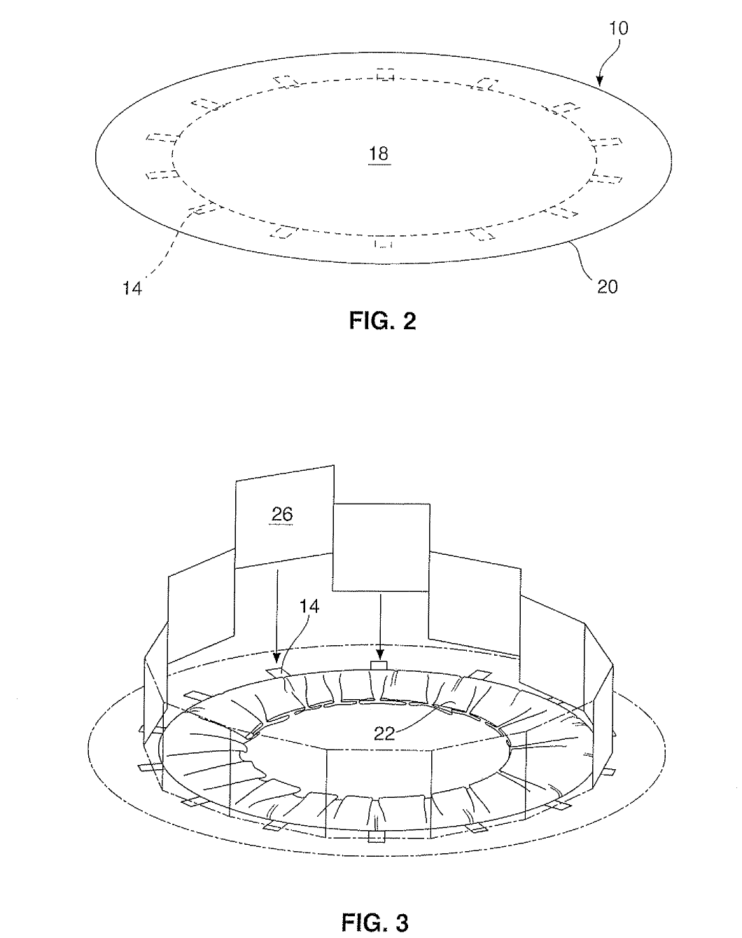

Referring to the remaining Figures and specifically FIGS. 2 through 5, FIG. 2 illustrates the liner 10 where the top surface, denoted by numeral 18 is shown in a face up disposition. The stabilizing members 14 are illustrated in chain line owing to the fact that the liner is now in a position for use. It will be noted that the stabilizing members do not extend to the outer periphery 20 of liner 10; the stabilizing members need only be from about 10% to about 80% of the distance to the perimeter 20 of the liner 10.

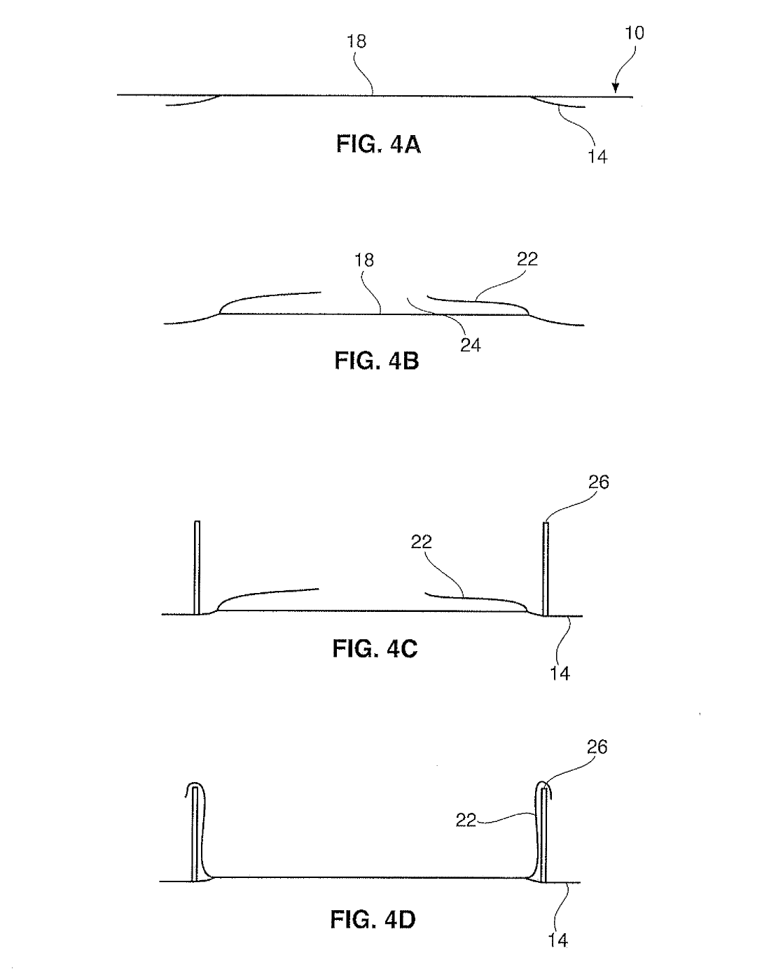

With respect to specific reference to FIGS. 4A through 4D, shown is a sequence of illustrations that demonstrates the use of the liner according to one embodiment of the present invention. In FIG. 4A, the liner 10 is shown in side view. This is where the stabilizing members 14 are beneath the top of the liner 18. In respect to FIG. 413, the stabilizing members 14 now extend outwardly from the liner 10 and in this embodiment the sidewalls or perimeter 22 of the liner 10 are folded upwardly and inwardly towards a centre point denoted by numeral 24 in FIG. 4B.

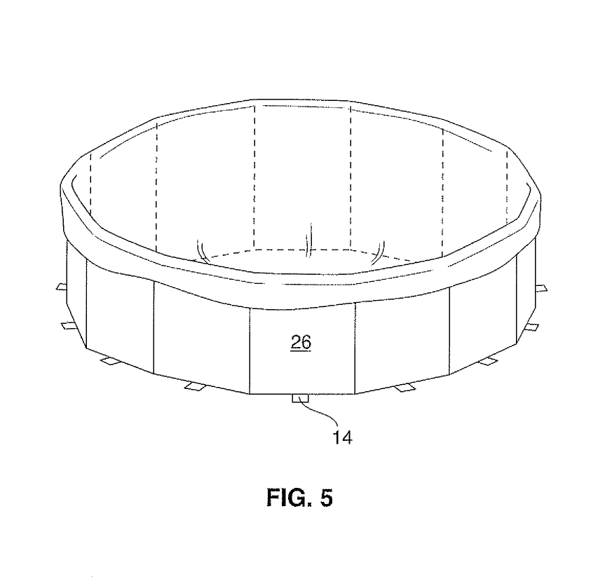

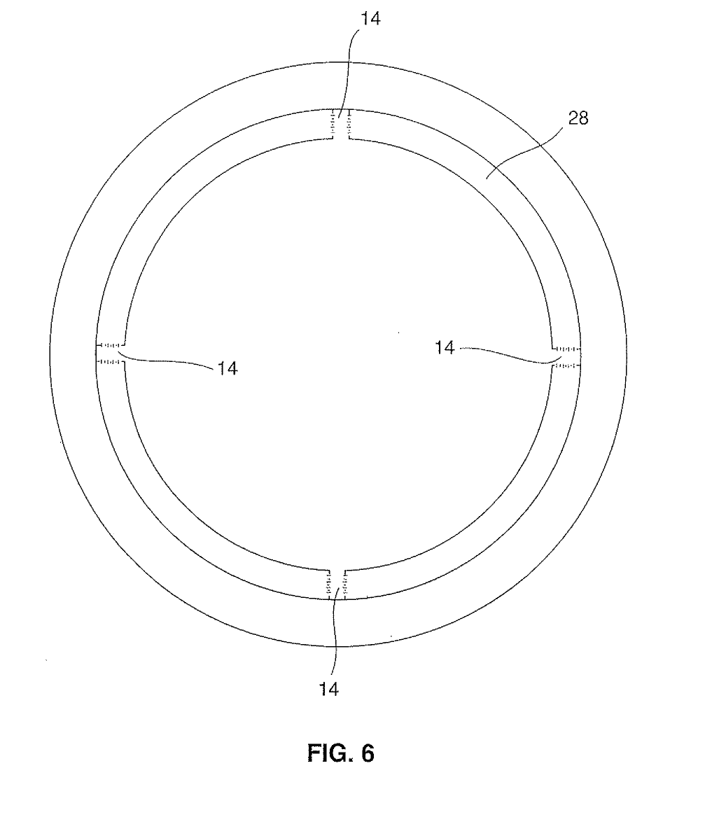

Once the sidewalls 22 are folded as indicated in FIG. 4B, the structural sidewalls 26 shown in FIGS. 3, 4C and 4D are positioned on the top of the stabilizing members 14. The sidewalls 22 are then folded upwardly and then over the top of the sidewalls 26 as shown in FIG. 4D. This overall process and the structural relationship between the elements is best shown in FIG. 3. FIG. 5 illustrates a perspective view of the overall structure once it is completely assembled.

It has been found that this structure and method for assembling a container to hold a liquid and the liner therein is particularly effective and obviates all of the dangers typically associated with workers attempting to “drop-in” a liner into a premade container composed of sidewalls 26. By providing the stabilizing members 14 about the periphery of the liner, the tension of the liner can always be maintained at the base 18 and the stability of the liner during assembly of the container sidewalls 26. It will be clear to those skilled in the art that this structure and method of assembly prevents the possibility of air currents coming underneath the liner which would otherwise create billowing and a dangerous manipulation situation. The sidewalls 26, due to the weight thereof, retain the liner in position and do not allow air current or air flow under the base. With respect to the flexible sidewalls 22 of the liner 10, these are unaffected by any type of air flow or wind currents, since they are within the body of the container being formed and are thus essentially unaffected by air flow over the top of the sidewalls 26.

In terms of a method using the liner of the present invention, the description for FIGS. 4A through 4D effectively delineates the steps involved in assembly. The liner 10 is positioned with the tabs 14 on the under surface, the sidewalls 22 of the flexible material of the liner 10 are folded inwardly towards the centre 18 of the base 24, the structural sidewalls 26 are positioned on the top of each stabilizing members 14 and the flexible sidewalls 22 are positioned adjacent the sidewalls 26 and folded over the top of the sidewalls 26. The top portions are then fixedly secured with some suitable fastening means (not shown).

Turning to FIG. 6, shown is an alternative of the present invention. In this embodiment, the stabilizing members 14 are spaced about the periphery of the liner 10 as noted with respect to the previous figures. In this embodiment, only four stabilizing members are shown. Between adjacent stabilizing members 14, this embodiment provides an arcuate segment 28 extending therebetween. The arcuate segments 28 function as a stabilizing member or means. To this end, the tab style stabilizing members 14 effectively function as spacers to retain independent sections of the arcuate segments 28. As with the stabilizing members 14, the arcuate segments 28 can function to retain and maintain position of the liner during assembly of the container sidewalls 26.

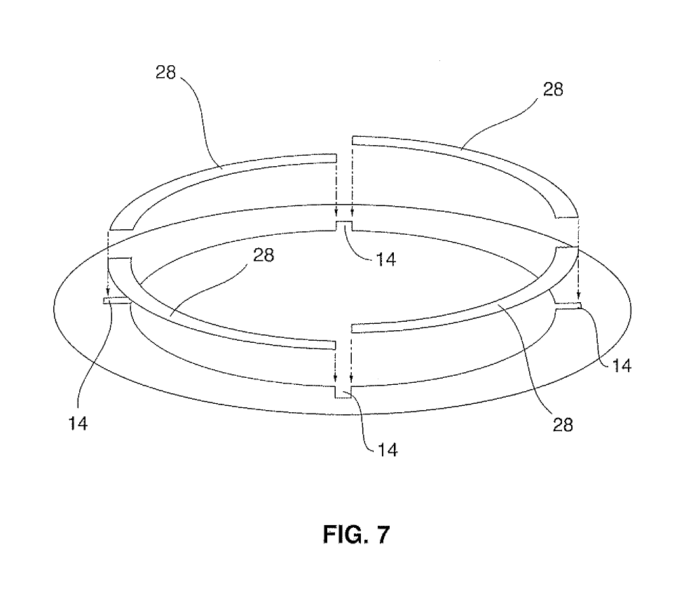

Referring to FIG. 7, the same illustrates an exploded view of the embodiment of FIG. 6 more clearly depicting the arcuate segments 28.

Although embodiments of the invention have been described above, it is not limited thereto and it will be apparent to those skilled in the art that numerous modifications form part of the present invention insofar as they do not depart from the spirit, nature and scope of the claimed and described invention.

I claim:

1. A liner for a tank adapted to retain liquid, comprising:
a liner body adapted to form a base and at least one vertical wall in a continuous structure, said at least one vertical wall of said liner adapted for folding over a supporting wall section; and
stabilizing means integral with and positioned about the base of said liner for stabilizing motion of said liner during assembly of said wall section when said wall section is positioned on top of said stabilizing means.

2. The liner as set forth in claim 1, wherein said stabilizing means comprising individual segments extending outwardly from the periphery of said liner base when said at least one vertical wall is folded over said segment.

3. The liner as set forth in claim 2, wherein said individual segments are equidistantly spaced.

4. The liner as set forth in claim 2, further including retainer means for retaining said stabilizing means.

5. The liner as set forth in claim 4, wherein said retainer means comprises a pouch.

6. The liner as set forth in claim 1, wherein said liner and said stabilizing means comprises HDPE or LLDPE.

7. A method stabilizing movement of a liner body during the lining of a container adapted to store a liquid, comprising:
providing a liner body having a base and walls folding to a substantially orthogonal position relative to said base;
providing integrally connected stabilizing means separate from said walls for extending perpetually from said base when said walls are folded;
positioning wall segments for forming said container on top of said stabilizing means; and
folding and securing liner walls over said wall segments, whereby said liner body and walls are stabilized against lift and movement during assembly of said container.
